(19) United States
(12) Patent Application Publication
(10) Pub. No.: US 2025/0036717 A1
(43) Pub. Date: Jan. 30, 2025

(54) ROBUST NONNEGATIVE MATRIX FACTORIZATION (RNMF) METHOD BASED ON DEEP LEARNING AND INCREMENTAL LEARNING

(71) Applicant: Chengdu University of Technology, Chengdu (CN)

(72) Inventors: Zhongli ZHOU, Chengdu (CN); Ran ZHOU, Chengdu (CN); Changjie CAO, Chengdu (CN); Bingli LIU, Chengdu (CN); Yunhui KONG, Chengdu (CN); Cheng LI, Chengdu (CN); Yueyun LIU, Chengdu (CN)

(21) Appl. No.: 18/911,883

(22) Filed: Oct. 10, 2024

(30) Foreign Application Priority Data
Dec. 8, 2023 (CN) 202311679765.8

(51) Int. Cl. G06F 17/16; G06N 3/09; G06V 10/764; G06V 10/77; G06V 10/774; G06V 10/776

(52) U.S. Cl. CPC G06F 17/16; G06N 3/09; G06V 10/764; G06V 10/7715; G06V 10/774; G06V 10/776

(57) ABSTRACT

A robust nonnegative matrix factorization (RNMF) method, in which an image sample set is split into a training set and a test set. The training set and the test set are normalized to map the image data from [0, 255] to [0, 1]. The training set matrix is pretrained by RNMF for decomposition. l_{2,1}-deep incremental nonnegative matrix factorization (l_{2,1}-DINMF) model is construed. The l_{2,1}-DINMF model is configured to decompose the training set matrix into l+1 factors. After the basis matrix has been updated, and the samples of the training set and samples to be recognized are projected into a feature space. Feature representations of the test set are classified by a trained SVM classifier to obtain a predicted label, and the predicted label is compared with an actual label of the test set to calculate a recognition accuracy.

### CROSS-REFERENCE TO RELATED APPLICATIONS

This application claims the benefit of priority from Chinese Patent Application No. 202311679765.8, filed on Dec. 8, 2023. The content of the aforementioned application, including any intervening amendments made thereto, is incorporated herein by reference in its entirety.

### TECHNICAL FIELD

This application relates to image recognition technology, and more particularly to a RNMF method based on deep learning and incremental learning.

### BACKGROUND

Feature extraction is a critical step in the image recognition tasks, by which the most representative and discriminative features can be extracted from complex high-dimensional raw data, thereby improving recognition accuracy and reducing recognition time. Nonnegative Matrix Factorization (NMF), as a common feature extraction algorithm, introduces positive-define constraints through specific multiplication update strategies to obtain feature representations that can better reflect the actual physical meaning, thereby revealing the intrinsic structure of the data. The core idea of NMF is to decompose the original data matrix into two non-negative matrices, emphasizing that an object can be composed of parts and reassembled through addition, reflecting the concept of “the whole is made up of parts”. However, NMF is susceptible to noise and outliers when processing data, causing the decomposition results to deviate from the true underlying structure, leading to extracted features that do not accurately reflect the true characteristics of the data, and thus making the model unstable. To address this, the research field has proposed the RNMF algorithm, which innovatively introduces the l_{2,1}-norm to constrain the loss function, effectively mitigating the adverse effects of outliers and noise on the calculation of squared errors.

As the volume of high-dimensional image data continues to increase, the training time for feature extraction models has significantly lengthened. Traditional training methods typically incorporate additional samples directly into the existing sample set and retrain the entire sample set. This method leads to repeated processing of training samples, significantly increasing computational costs. In response, the research field has proposed the Incremental Robust Nonnegative Matrix Factorization (IRNMF) algorithm, which enables the feature extraction model to update autonomously, greatly reducing training time and the storage space required for training samples, while ensuring the stability of the model.

The aforementioned algorithms, due to all single-layer structures, are insufficient for providing comprehensive data representation for complex, multi-dimensional data. In contrast, deep learning, through hierarchical extraction and progressive abstraction, can automatically learn complex feature representations from the data, significantly enhancing classification accuracy and reliability. Therefore, applying deep learning to IRNMF could not only reduce storage space and training time while ensuring model stability, but also autonomously learn the latent attributes and hidden information of target images, thereby extracting deeper features and further improving recognition accuracy. This would undoubtedly be a superior feature extraction method.

### SUMMARY

To overcome the shortcomings of traditional feature extraction methods in extraction of the deep features of the target images, and to achieve autonomous learning of the latent attributes and hidden information of the target images while reducing time costs and maintaining model stability, the present application constructs a novel NMF model framework based on deep learning principles to provide a l_{2,1}-Contrained Deep Incremental Nonnegative Matrix Factorization (l_{2,1}-DINMF) method.

A RNMF method based on deep learning and incremental learning is provided, comprising:
(S1) splitting an image sample dataset into a training set and a test set, wherein a ratio of the training set to the test set is 8:2; and normalizing the training set and the test set to map image data from [0, 255] to [0, 1]; wherein a data matrix of the training set is expressed as V∈R^{m×n}, wherein n represents the number of image samples of the training set, columns of the data matrix of the training set respectively represent the image samples of the training set, m represents the number of features in each of the image samples of the training set, and the image samples of the training set are randomly distributed;
(S2) initializing the data matrix V of the training set by robust nonnegative matrix factorization (RNMF) through steps of:
   decomposing the data matrix V of the training set into a basis matrix and a feature matrix, and obtaining a diagonal element matrix D∈R^{r×r}; wherein a loss function of the RNMF under a L_{2,1} sparsity constraint is represented by:

$$F = {‖ V - WH ‖}_{F}^{2 , 1} = {\sum }_{b = 1}^{n} \sqrt{{\sum }_{a = 1}^{m} {( V - W H )}_{a b}^{2}} , s . t . W , H \geq 0 ;$$

wherein W represents the basis matrix, and W∈R^{m×r}; H represents the feature matrix, and H∈R^{r×n}; 2,1 represents a l_{2,1}-norm; a represents a row parameter, and m represents the number of rows; and b represents a column parameter, and n represents the number of columns;
obtaining a Karush-Kuhn-Tucker (KKT) condition of the feature matrix H under a constraint of H>0, represented by:

$$\frac{\partial F}{\partial ( {H}_{t b} )} {H}_{t b} = 0 ;$$

wherein t=1, . . . , r; and b=1, . . . , n;
obtaining a KKT condition of the basis matrix W under a constraint of W>0, represented by:

$$\frac{\partial F}{\partial ( {W}_{at} )} {W}_{at} = 0 ;$$

wherein a=1, . . . , m; and t=1, . . . , r;
updating the feature matrix according to a solution of the KKT condition of the feature matrix through the following formula:

$${H}_{t b} ← {H}_{t b} \frac{{( {W}^{T} V D )}_{t b}}{{( {W}^{T} W H D )}_{t b}} ;$$

updating the basis matrix according to a solution of the KKT condition of the basis matrix through the following formula:

$${W}_{a t} ← {W}_{a t} \frac{{( V D {H}^{T} )}_{a t}}{{( W H D {H}^{T} )}_{a t}} ;$$

wherein

$${D}_{b b} = \frac{1}{\sqrt{{\sum }_{a = 1}^{m} {( V - W H )}_{a b}^{2}}} ;$$

the updating of the feature matrix and the updating of the basis matrix are performed alternately, and elements of the basis matrix are updated after elements of the feature matrix have been updated;
(S3) constructing a l_{2,1}-deep incremental non-negative matrix factorization (DINMF) model, wherein the l_{2,1}-DINMF model is configured to decompose the data matrix V of the training set into l+1 factors, expressed as;

$$V \approx {W}_{1} {W}_{2} … {W}_{l} {H}_{l} ;$$

wherein an implicit hierarchical framework of the l_{2,1}-DINMF model is represented by:

$$\begin{matrix}{H}_{l - 1} \approx {W}_{l} {H}_{l} \\ ⋮ \\ {H}_{2} \approx {W}_{3} … {W}_{l} {H}_{l} \\ {H}_{1} \approx {W}_{2} … {W}_{l} {H}_{l} \\ V \approx {W}_{1} … {W}_{l} {H}_{l} ;\end{matrix}$$

when the number of the image samples of the training set is k, representing the loss function as:

$${F}_{k} = {‖ {V}_{k} - {W}_{1}^{k} {W}_{2}^{k} … {W}_{l}^{k} {H}_{l}^{k} ‖}_{2 , 1} = {\sum }_{j = 1}^{k} \sqrt{{\sum }_{i = 1}^{m} {( {V}_{k} - {W}_{1}^{k} {W}_{2}^{k} ⋯ {W}_{l}^{k} {H}_{l}^{k} )}_{i j}^{2}} ;$$

wherein Hₗ^{k} represents a feature matrix of a l-th layer, and Wₛ^{k}(s∈1, 2, . . . , l) represents a basis matrix of a s-th layer;
introducing a new image sample based on Incremental Nonnegative Matrix Factorization (INMF), and rewriting the loss function as follows:

$${F}_{k} \approx {\sum }_{j = 1}^{k} \sqrt{{\sum }_{i = 1}^{m} {( {V}_{k} - {W}_{1}^{k + 1} {W}_{2}^{k + 1} ⋯ {W}_{l}^{k + 1} {H}_{l}^{k} )}_{i j}^{2}} ;$$

wherein Wₛ^{k+1}(s∈1, 2, . . . , l) represents a basis matrix of the s-th layer when the number of the image samples of the training set is k+1;
after the new image sample is introduced for model training, updating the basis matrix W globally and updating the feature matrix H locally using a l_{2,1}-DINMF algorithm to enable incremental learning;
wherein when the number of the new image sample is 1, the loss function is expressed as:

$$\begin{matrix}{F}_{k + 1} = {‖ {V}_{k + 1} - {W}_{1}^{k + 1} {W}_{2}^{k + 1} … {W}_{l}^{k + 1} {H}_{l}^{k + 1} ‖}_{2 , 1} \\ = {\sum }_{j = 1}^{k + 1} \sqrt{{\sum }_{i = 1}^{m} {( {V}_{k + 1} - {W}_{1}^{k + 1} {W}_{2}^{k + 1} ⋯ {W}_{l}^{k + 1} {H}_{l}^{k + 1} )}_{ij}^{2}} \\ \approx {\sum }_{j = 1}^{k + 1} \sqrt{{\sum }_{i = 1}^{m} {( {V}_{k + 1} - {W}_{1}^{k + 1} {W}_{2}^{k + 1} ⋯ {W}_{l}^{k + 1} {H}_{l}^{k + 1} )}_{ij}^{2}} + \sqrt{{\sum }_{i = 1}^{m} {( {V}_{k + 1} - {W}_{1}^{k + 1} {W}_{2}^{k + 1} ⋯ {W}_{l}^{k + 1} {H}_{l}^{k + 1} )}_{i}^{2}} \\ \approx {F}_{k} + {f}_{k + 1}\end{matrix}$$

wherein vₖ₊₁ represents the new image sample, and hₗ^{k+1} represents data of a last column of a feature matrix Hₗ^{k+1};
introducing the following parameters:

$${P}_{s - 1} = {W}_{1}^{k + 1} {W}_{2}^{k + 1} … {W}_{s - 1}^{k + 1} ( \begin{matrix}if & s = 1 & {P}_{s - 1} = I ) ;\end{matrix}$$

$${Q}_{s + 1} = {W}_{s + 1}^{k + 1} {W}_{s + 2}^{k + 1} … {W}_{l}^{k + 1} ( \begin{matrix}if & s = l & {Q}_{s + 1} = I ) ;\end{matrix}$$

$${D}_{s}^{k + 1} = \frac{1}{\sqrt{{\sum }_{i = 1}^{m} {( {V}_{k + 1} - {P}_{s - 1} {W}_{s}^{k + 1} {Q}_{s + 1} {H}_{l}^{k + 1} )}_{i}^{2}}} \approx \frac{1}{\sqrt{{\sum }_{i = 1}^{m} {( {V}_{k} - {P}_{s - 1} {W}_{s}^{k + 1} {Q}_{s + 1} {H}_{l}^{k} )}_{i}^{2}}} + {d}_{s}^{k + 1} ;$$

$${d}_{s}^{k + 1} = \frac{1}{\sqrt{{\sum }_{i = 1}^{m} {( {v}_{k + 1} - {P}_{s - 1} {W}_{s}^{k + 1} {Q}_{s + 1} {h}_{l}^{k + 1} )}_{i}^{2}}} ;$$

updating the loss function as follows:

$${F}_{k + 1} = {\sum }_{j = 1}^{k + 1} \sqrt{{\sum }_{i = 1}^{m} {( {V}_{k + 1} - {P}_{s - 1} {W}_{s}^{k + 1} {Q}_{s + 1} {H}_{l}^{k + 1} )}_{i j}^{2}} ;$$

updating Wₛ^{k+1} according to an additive updating rule, expressed as:

$${W}_{s}^{k + 1} = {W}_{s}^{k + 1} - {γ}_{s}^{k + 1} \frac{\partial {F}_{k + 1}}{\partial {W}_{s}^{k + 1}} ;$$

wherein a step size for updating Wₛ^{k+1} is determined as follows:

$${γ}_{S}^{k + 1} = \frac{{W}_{S}^{k + 1}}{{P}_{S - 1}^{T} {P}_{S - 1} {W}_{S}^{k + 1} {Q}_{S + 1} {{H}_{l}^{k + 1} ( {H}_{l}^{k + 1} )}^{T} {Q}_{S + 1}^{T}} ;$$

calculating a partial derivative of Fₖ₊₁ with respect to Wₛ^{k+1}, expressed as:

$$\frac{\partial {F}_{k + 1}}{\partial {W}_{s}^{k + 1}} = - {P}_{s - 1}^{T} {V}_{k + 1} {{D}_{s}^{k + 1} ( {H}_{l}^{k + 1} )}^{T} {Q}_{s + 1}^{T} + {P}_{s - 1}^{T} {P}_{s - 1} {W}_{s}^{k + 1} {Q}_{s + 1} {H}_{l}^{k + 1} {{D}_{s}^{k + 1} ( {H}_{l}^{k + 1} )}^{T} {Q}_{s + 1}^{T} ;$$

$${W}_{s}^{k + 1} = {W}_{s}^{k + 1} \cdot \frac{{P}_{s - 1}^{T} {P}_{s - 1} {W}_{s}^{k + 1} {Q}_{s + 1} {{H}_{l}^{k + 1} ( {H}_{l}^{k + 1} )}^{T} {Q}_{s - 1}^{T} + {P}_{s - 1}^{T} {V}_{k + 1} {{D}_{s}^{k + 1} ( {H}_{l}^{k + 1} )}^{T} {Q}_{s + 1}^{T}}{{P}_{s - 1}^{T} {P}_{s - 1} {W}_{s}^{k + 1} {Q}_{s + 1} {{H}_{l}^{k + 1} ( {H}_{l}^{k + 1} )}^{T} {Q}_{s + 1}^{T}} - \frac{{P}_{s - 1}^{T} {P}_{s - 1} {W}_{s}^{k + 1} {Q}_{s + 1} {H}_{l}^{k + 1} {{D}_{s}^{k + 1} ( {H}_{l}^{k + 1} )}^{T} {Q}_{s + 1}^{T}}{{P}_{s - 1}^{T} {P}_{s - 1} {W}_{s}^{k + 1} {Q}_{s + 1} {{H}_{l}^{k + 1} ( {H}_{l}^{k + 1} )}^{T} {Q}_{s + 1}^{T}} ;$$

$${F}_{k + 1} \approx {\sum }_{j = 1}^{k} \sqrt{{\sum }_{i = 1}^{m} {( {V}_{k} - {G}_{l} {H}_{l}^{k} )}_{i j}^{2}} + \sqrt{{\sum }_{i = 1}^{m} {( {v}_{k + 1} - {G}_{l} {h}_{l}^{k + 1} )}_{i j}^{2}} ;$$

$${h}_{l}^{k + 1} = {h}_{l}^{k + 1} - {β}_{l}^{k + 1} \frac{\partial {F}_{k + 1}}{\partial {h}_{l}^{k + 1}} ;$$

$${β}_{l}^{k + 1} = \frac{{h}_{l}^{k + 1}}{{G}_{l}^{T} {G}_{l} {h}_{l}^{k + 1}} ;$$

$$\frac{\partial {F}_{k + 1}}{\partial {h}_{l}^{k + 1}} = {G}_{l}^{T} {G}_{l} {h}_{l}^{k + 1} {d}_{l}^{k + 1} - {G}_{l}^{T} {v}_{k + 1} {d}_{l}^{k + 1} ;$$

updating hₗ^{k+1} according to the following formula:

$${h}_{l}^{k + 1} = {h}_{l}^{k + 1} \cdot \frac{{G}_{l}^{T} {G}_{l} {h}_{l}^{k + 1} + {G}_{l}^{T} {v}_{k + 1} {d}_{l}^{k + 1} - {G}_{l}^{T} {G}_{l} {h}_{l}^{k + 1} {d}_{l}^{k + 1}}{{G}_{l}^{T} {G}_{l} {h}_{l}^{k + 1}} ;$$

wherein hₛ^{k+1} is obtained by multiplying hₛ₊₁^{k+1} by Wₛ₊₁^{k+1}, expressed as;

$${h}_{s}^{k + 1} = {W}_{s + 1}^{k + 1} {h}_{s + 1}^{k + 1} ;$$

wherein s is smaller than l; and
an updating rule of the hₛ^{k+1} is represented by:

$${h}_{s}^{k + 1} = \{ \begin{matrix}{W}_{s + 1}^{k + 1} {h}_{s + 1}^{k + 1} , s \neq l \\ {h}_{s}^{k + 1} \cdot \frac{{G}_{l}^{T} {G}_{l} {h}_{s}^{k + 1} + {G}_{l}^{T} {v}_{k + 1} {d}_{s}^{k + 1} - {G}_{l}^{T} {G}_{l} {h}_{s}^{k + 1} {d}_{s}^{k + 1}}{{G}_{l}^{T} {G}_{l} {h}_{l}^{k + 1}} , s = l\end{matrix} ;$$

and
(S4) after updating of the basis matrix W is completed, projecting the image samples of the training set and samples to be recognized into a feature space W through steps of:
   re-projecting the image samples of the training set to train a support vector machine (SVM) classifier, represented by:

$${H}_{train} = {( {G}_{l}^{T} {G}_{l} )}^{- 1} {G}_{l}^{T} {V}_{train} ;$$

wherein Hₜᵣₐᵢₙ represents a projection of a data matrix of the training set in the feature space, and Hₜᵣₐᵢₙ∈R^{r×n}, Vₜᵣₐᵢₙ represents a current data matrix of the training set, and Vₜᵣₐᵢₙ∈R^{m×n};
projecting the samples to be recognized as follows:

$${h}_{test} = {( {G}_{l}^{T} {G}_{l} )}^{- 1} {G}_{l}^{τ} {v}_{test} ;$$

wherein the samples to be recognized are image samples in the test set; hₜₑₛₜ represents a projection of a sample recognition vector in the feature space, and hₜₑₛₜ∈R^{r×q}, vₜₑₛₜ represents the sample recognition vector, and vₜₑₛₜ∈R^{p×q}; and
classifying feature representations hₜₑₛₜ of the test set by a trained SVM classifier to obtain a predicted label, and comparing the predicted label with an actual label of the test set to calculate recognition accuracy.

In an embodiment, in step (S3), every time the updating of the training set is completed, a current iteration result of each layer and a historical information are saved for next update; wherein the current iteration result comprises hₛ^{k+1}, dₛ^{k+1} and Wₛ^{k+1}, and the historical information comprises vₖ₊₁, Aₛ and Bₛ, and Aₛ and Bₛ are respectively expressed by:

$${A}_{s} = \{ \begin{matrix}\begin{matrix}[ {W}_{s}^{k} {{H}_{s}^{k} ( {H}_{s}^{k} )}^{T} + {V}^{k} {{D}_{s}^{k} ( {H}_{s}^{k} )}^{T} - {W}_{s}^{k} {H}_{s}^{k} {{D}_{s}^{k} ( {H}_{s}^{k} )}^{T} ] + \\ [ {W}_{s}^{k + 1} {{h}_{s}^{k + 1} ( {h}_{s}^{k + 1} )}^{T} + {v}_{k + 1} {{d}_{s}^{k + 1} ( {h}_{s}^{k + 1} )}^{T} - {W}_{s}^{k + 1} {h}_{s}^{k + 1} {{d}_{s}^{k + 1} ( {h}_{s}^{k + 1} )}^{T} ] ,\end{matrix} & if s = 1 \\ \begin{matrix}[ {W}_{s}^{k} {{H}_{s}^{k} ( {H}_{s}^{k} )}^{T} + {H}_{s - 1}^{k} {{D}_{s}^{k} ( {H}_{s}^{k} )}^{T} - {W}_{s}^{k} {H}_{s}^{k} {{D}_{s}^{k} ( {H}_{s}^{k} )}^{T} ] + \\ [ {W}_{s}^{k + 1} {{h}_{s}^{k + 1} ( {h}_{s}^{k + 1} )}^{T} + {h}_{s - 1}^{k + 1} {{d}_{s}^{k + 1} ( {h}_{s}^{k + 1} )}^{T} - {W}_{s}^{k + 1} {h}_{s}^{k + 1} {{d}_{s}^{k + 1} ( {h}_{s}^{k + 1} )}^{T} ] ,\end{matrix} & otherwise\end{matrix}$$

$${B}_{s} = {{H}_{s}^{k} ( {H}_{s}^{k} )}^{T} + {{h}_{s}^{k + 1} ( {h}_{s}^{k + 1} )}^{T} ;$$

wherein s=1, 2, . . . , l.

This present application provides a l_{2,1}-DINMF method based on traditional RNMF. The method combines the advantages of incremental learning and deep networks, enabling the extraction of hidden information from complex data while maintaining the characteristic of “the whole being composed of parts.” On the basis of meeting the KKT conditions, the update rule with a relatively fast convergence speed is obtained according to l_{2,1}-DINMF algorithm, which not only significantly reduces time loss and storage requirements for training samples but also ensures the stability of the feature extraction. It effectively resolves the contradiction between high precision of recognition and efficiency of feature update in traditional feature extraction.

In summary, compared to existing feature extraction methods, the present application combines the advantages of deep learning and incremental online learning, reducing redundant training, improving recognition accuracy, and significantly shortening training time. It extracts deep-level features from images while maintaining the stability of the model.

### BRIEF DESCRIPTION OF THE DRAWINGS

FIG. 1 illustrates a portion of the sample images from the HeadPose Image dataset according to an embodiment of the present disclosure;

FIG. 2 is a flowchart of a RNMF method based on deep learning and incremental learning according to an embodiment of the present disclosure;

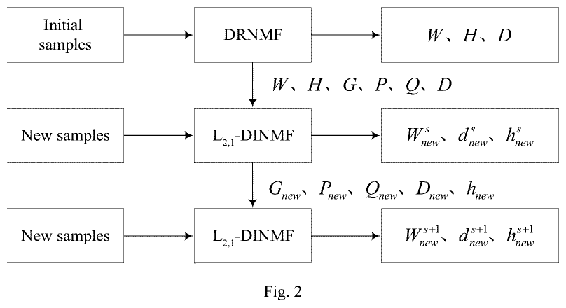

FIG. 3 illustrates the recognition rate for incremental learning tasks in facial image recognition, comparing six methods according to an embodiment of the present disclosure;

FIG. 4 illustrates the time loss for incremental learning tasks in facial image recognition, comparing six methods according to an embodiment of the present disclosure; and

FIG. 5 illustrates the space loss for incremental learning tasks in facial image recognition, comparing six methods according to an embodiment of the present disclosure.

### DETAILED DESCRIPTION OF EMBODIMENTS

The present disclosure is described in detail through a simulation of practical applications based on deep learning and incremental learning, using the task of recognizing 15 classes of target images from the HeadPose Image dataset as an example.

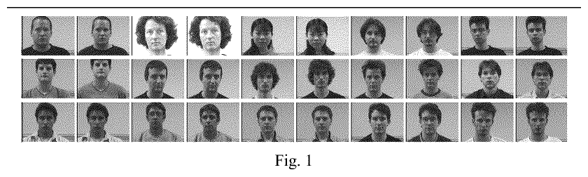

The experiment is based on the HeadPose Image dataset. The size of the original image is 384×288 in raw data format. To improve the processing efficiency, the images were downsampled, allowing the sample size of the final image to be 96×72 in raw data format. The experiment was programmed using MATLAB 2019b, with the operating environment being Windows 10 and the processor being an Intel® Core™ i7-9700 CPU @ 3.00 GHz. The examples of target images can be seen in FIG. 1.

The total number of training samples in the experiment was 2,235, and the total number of test samples was 555. The samples were collected from 15 subjects, covering different lighting conditions, postures, and facial features. The training samples were divided into two parts: initial samples and additional samples. The number of initial samples was set to 300, while additional samples were added in batches, with each batch consisting of 300 samples. The following six methods were evaluated, including NMF, RNMF, IRNMF, Deep Nonnegative Matrix Factorization (DNMF), Deep Robust Nonnegative Matrix Factorization (DRNMF), and l_{2,1}-DINMF.

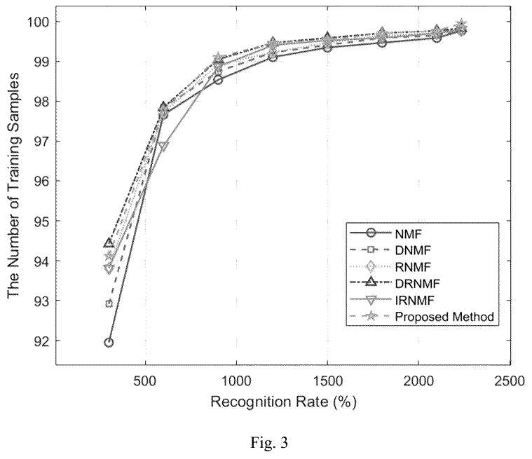

Firstly, the recognition accuracy of the six methods was recorded as the number of samples increased, as shown in FIG. 3. From FIG. 3, it can be observed that the recognition accuracy of l_{2,1}-DINMF is significantly better than that of NMF, RNMF, IRNMF, and DNMF. Compared to DRNMF, l_{2,1}-DINMF also performs better in terms of final recognition accuracy, reaching 99.9399%. Moreover, during the incremental process, the learning performance of l_{2,1}-DINMF consistently improves with the increase in the number of training samples and maintains stable growth.

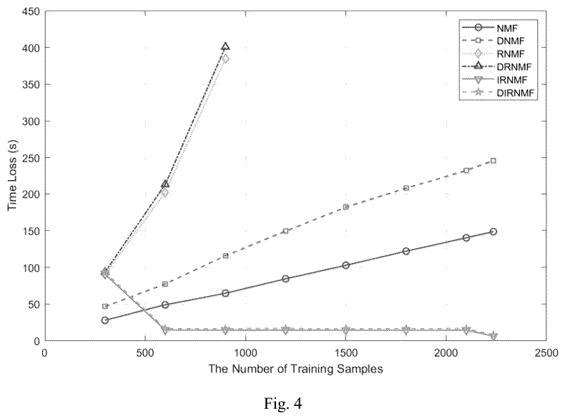

Secondly, the time loss of the six feature extraction methods was recorded, as shown in FIG. 4, as the number of samples increased. Due to the additional time required by RNMF and DRNMF to handle noise and outliers during the update of the automatic target recognition model, the relationship between time loss and the number of samples is superlinear. As the number of target samples increases, the time loss of these two methods increases rapidly. In this experiment, only the time loss data of the first 900 samples were shown for RNMF and DRNMF. Since the l_{2,1}-DINMF algorithm avoids redundant learning to reduce computational costs, its time loss is almost unaffected by the number of target samples. Moreover, as the number of target samples increases, the advantage of the incremental learning method in terms of time loss becomes more prominent.

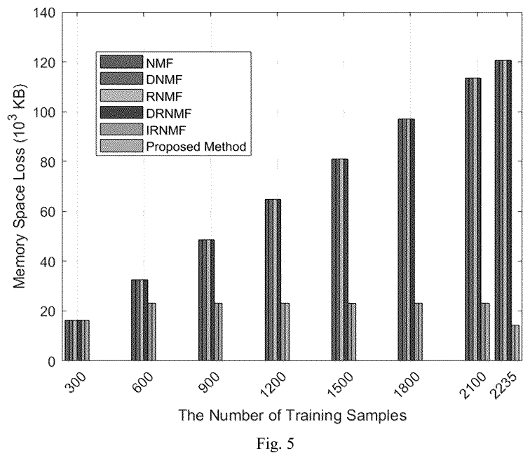

Finally, the memory space required by the above six feature extraction methods was recorded, as shown in FIG. 5. The stored data required by these six methods are listed in Table 1. As shown in FIG. 5, the loss of the memory space of NMF, DNMF, RNMF, and DRNMF shows a linear growth trend as the number of target samples increases. In contrast, the loss of the memory space of RNMF and l_{2,1}-DINMF is almost unaffected by the increase in target samples. Except for the loss of the memory space during the initialization phase, the loss of the memory space remains stable in other stages. When the size of the dataset reaches 2,235, l_{2,1}-DINMF method uses only 11.8% of the memory compared to DNMF.

TABLE 1

| Algorithm | Stored Data |
|---|---|
| NMF | all training samples |
| DNMF | all training samples |
| RNMF | all training samples |
| DRNMF | all training samples |
| IRNMF | W, A, B, d, |
| | additional samples |
| DIRNMF | W, A, B, d, |
| | additional samples |

The experiment result demonstrates that l_{2,1}-DINMF can not only extract the deep-level features, but also possess the advantages of RNMF in terms of avoiding the impact of noise and outliers and the advantages of incremental learning in terms of preventing the redundant learning. Therefore, it can efficiently and stably complete the feature extraction task of image recognition.

What is claimed is:

1. A robust nonnegative matrix factorization (RNMF) method based on deep learning and incremental learning, comprising:
(S1) splitting an image sample dataset into a training set and a test set, wherein a ratio of the training set to the test set is 8:2; and normalizing the training set and the test set to map image data from [0, 255] to [0, 1]; wherein a data matrix of the training set is expressed as V∈R^{m×n}, wherein n represents the number of image samples of the training set, columns of the data matrix of the training set respectively represent the image samples of the training set, m represents the number of features in each of the image samples of the training set, and the image samples of the training set are randomly distributed;
(S2) initializing the data matrix V of the training set by robust nonnegative matrix factorization (RNMF) through steps of:
decomposing the data matrix V of the training set into a basis matrix and a feature matrix, and obtaining a diagonal element matrix D∈R^{r×r}; wherein a loss function of the RNMF under a L_{2,1} sparsity constraint is represented by:
$$F = {‖ V - WH ‖}_{F}^{2 , 1} = {\sum }_{b = 1}^{n} \sqrt{{\sum }_{a = 1}^{m} {( V - WH )}_{ab}^{2}} , s . t . W , H \geq 0 ;$$
wherein W represents the basis matrix, and W∈R^{m×r}; H represents the feature matrix, and H∈R^{r×n}; 2,1 represents a l_{2,1}-norm; a represents a row parameter, and m represents the number of rows; and b represents a column parameter, and n represents the number of columns;
obtaining a Karush-Kuhn-Tucker (KKT) condition of the feature matrix H under a constraint of H>0, represented by:
$$\frac{\partial F}{\partial ( {H}_{tb} )} {H}_{tb} = 0 ;$$
wherein t= . . . r; and b=1, . . . , n;
obtaining a KKT condition of the basis matrix W under a constraint of W>0, represented by:
$$\frac{\partial F}{\partial ( {W}_{at} )} {W}_{at} = 0 ;$$
wherein a=1, . . . , m; and t=1, . . . , r;
updating the feature matrix according to a solution of the KKT condition of the feature matrix through the following formula:
$${H}_{tb} ← {H}_{tb} \frac{{( {W}^{T} VD )}_{tb}}{{( {W}^{T} WHD )}_{tb}} ;$$
updating the basis matrix according to a solution of the KKT condition of the basis matrix through the following formula:
$${W}_{at} ← {W}_{at} \frac{{( {VDH}^{T} )}_{at}}{{( {WHDH}^{T} )}_{at}} ;$$
wherein
$${D}_{bb} = \frac{1}{\sqrt{{\sum }_{a = 1}^{m} {( V - WH )}_{a b}^{2}}} ;$$
the updating of the feature matrix and the updating of the basis matrix are performed alternately, and elements of the basis matrix are updated after elements of the feature matrix have been updated;
(S3) constructing a l_{2,1}-deep incremental non-negative matrix factorization (DINMF) model, wherein the l_{2,1}-DINMF model is configured to decompose the data matrix V of the training set into l+1 factors, expressed as;
$$V \approx {W}_{1} {W}_{2} … {W}_{l} {H}_{l} ;$$
wherein an implicit hierarchical framework of the l_{2,1}-DINMF model is represented by:
$${H}_{l - 1} \approx {W}_{l} {H}_{l}$$
$$⋮$$
$${H}_{2} \approx {W}_{3} … {W}_{l} {H}_{l}$$
$${H}_{1} \approx {W}_{2} … {W}_{l} {H}_{l}$$
$$V \approx {W}_{1} … {W}_{l} {H}_{l} ;$$
when the number of the image samples of the training set is k, representing the loss function as:
$${F}_{k} = {‖ {V}_{k} - {W}_{1}^{k} {W}_{2}^{k} … {W}_{l}^{k} {H}_{l}^{k} ‖}_{2 , 1} = {\sum }_{j = 1}^{k} \sqrt{{\sum }_{i = 1}^{m} {( {V}_{k} - {W}_{1}^{k} {W}_{2}^{k} … {W}_{l}^{k} {H}_{l}^{k} )}_{i j}^{2}} ;$$
wherein Hₗ^{k} represents a feature matrix of a l-th layer, and Wₛ^{k}(s∈1, 2, . . . , l) represents a basis matrix of a s-th layer;
introducing a new image sample based on Incremental Nonnegative Matrix Factorization (INMF), and rewriting the loss function as follows:
$${F}_{k} \approx {\sum }_{j = 1}^{k} \sqrt{{\sum }_{i = 1}^{m} {( {V}_{k} - {W}_{1}^{k + 1} {W}_{2}^{k + 1} … {W}_{l}^{k + 1} {H}_{l}^{k} )}_{i j}^{2}} ;$$
wherein Wₛ^{k+1}(s∈1, 2, . . . , l) represents a basis matrix of the s-th layer when the number of the image samples of the training set is k+1;
after the new image sample is introduced for model training, updating the basis matrix W globally and updating the feature matrix H locally using a l_{2,1}-DINMF algorithm to enable incremental learning;
wherein when the number of the new image sample is 1, the loss function is expressed as:
$$\begin{matrix}{F}_{k + 1} = {‖ {V}_{k + 1} - {W}_{1}^{k + 1} {W}_{2}^{k + 1} … {W}_{l}^{k + 1} {H}_{l}^{k + 1} ‖}_{2 , 1} \\ = {\sum }_{j = 1}^{k + 1} \sqrt{{\sum }_{i = 1}^{m} {( {V}_{k + 1} - {W}_{1}^{k + 1} {W}_{2}^{k + 1} … {W}_{l}^{k + 1} {H}_{l}^{k + 1} )}_{ij}^{2}} \\ \approx {\sum }_{j = 1}^{k} \sqrt{{\sum }_{i = 1}^{m} {( {V}_{k} - {W}_{1}^{k + 1} {W}_{2}^{k + 1} … {W}_{l}^{k + 1} {H}_{l}^{k} )}_{ij}^{2}} + \\ \sqrt{{\sum }_{i = 1}^{m} {( {v}_{k + 1} - {W}_{1}^{k + 1} {W}_{2}^{k + 1} … {W}_{l}^{k + 1} {h}_{l}^{k + 1} )}_{i}^{2}} \\ \approx {F}_{k} + {f}_{k + 1} ;\end{matrix}$$
wherein vₖ₊₁ represents the new image sample, and h represents data of a last column of a feature matrix Hₗ^{k+1};
introducing the following parameters:
$${P}_{s - 1} = {W}_{1}^{k + 1} {W}_{2}^{k + 1} … {W}_{s - 1}^{k + 1} ( if s = 1 {P}_{s - 1} = I ) ;$$
$${Q}_{s + 1} = {W}_{s + 1}^{k + 1} {W}_{s + 2}^{k + 1} … {W}_{l}^{k + 1} ( if s = l {Q}_{s + 1} = I ) ;$$
$${D}_{s}^{k + 1} = \frac{1}{\sqrt{{\sum }_{i = 1}^{m} {( {V}_{k + 1} - {P}_{s - 1} {W}_{s}^{k + 1} {Q}_{s + 1} {H}_{l}^{k + 1} )}_{i}^{2}}} \approx \frac{1}{\sqrt{{\sum }_{i = 1}^{m} {( {V}_{k} - {P}_{s - 1} {W}_{s}^{k + 1} {Q}_{s + 1} {H}_{l}^{k} )}_{i}^{2}}} + {d}_{s}^{k + 1} ;$$
$${d}_{s}^{k + 1} = \frac{1}{\sqrt{{\sum }_{i = 1}^{m} {( {v}_{k + 1} - {P}_{s - 1} {W}_{s}^{k + 1} {Q}_{s + 1} {h}_{l}^{k + 1} )}_{i}^{2}}} ;$$
updating the loss function as follows:
$${F}_{k + 1} = {\sum }_{j = 1}^{k + 1} \sqrt{{\sum }_{i = 1}^{m} {( {V}_{k + 1} - {P}_{s - 1} {W}_{s}^{k + 1} {Q}_{s + 1} {H}_{l}^{k + 1} )}_{ij}^{2}} ;$$
updating Wₛ^{k+1} according to an additive updating rule, expressed as:
$${W}_{S}^{k + 1} = {W}_{S}^{k + 1} - {γ}_{S}^{k + 1} \frac{\partial {F}_{k + 1}}{\partial {W}_{S}^{k + 1}} ;$$
wherein a step size for updating Wₛ^{k+1} is determined as follows:
$${γ}_{S}^{k + 1} = \frac{{W}_{S}^{k + 1}}{{P}_{S - 1}^{T} {P}_{S - 1} {W}_{S}^{k + 1} {Q}_{S + 1} {{K}_{l}^{k + 1} ( {H}_{l}^{k + 1} )}^{T} {Q}_{S + 1}^{T}} ;$$
calculating a partial derivative of Fₖ₊₁ with respect to Wₛ^{k+1} expressed as:
$$\frac{\partial {F}_{k + 1}}{\partial {W}_{s}^{k + 1}} = - {P}_{s - 1}^{T} {V}_{k + 1} {{D}_{s}^{k + 1} ( {H}_{l}^{k + 1} )}^{T} {Q}_{s + 1}^{T} + {P}_{s - 1}^{T} {P}_{s - 1} {W}_{s}^{k + 1} {Q}_{s + 1} {H}_{l}^{k + 1} {{D}_{s}^{k + 1} ( {H}_{l}^{k + 1} )}^{T} {Q}_{s + 1}^{T} ;$$
updating Wₛ^{k+1} as follows:
$${W}_{s}^{k + 1} = {W}_{s}^{k + 1} \cdot \frac{{P}_{s - 1}^{T} {P}_{s - 1} {W}_{s}^{k + 1} {Q}_{s + 1} {{H}_{l}^{k + 1} ( {H}_{l}^{k + 1} )}^{T} {Q}_{s - 1}^{T} + {P}_{s - 1}^{T} {V}_{k + 1} {{D}_{s}^{k + 1} ( {H}_{l}^{k + 1} )}^{T} {Q}_{s + 1}^{T}}{{P}_{s - 1}^{T} {P}_{s - 1} {W}_{s}^{k + 1} {Q}_{s + 1} {{H}_{l}^{k + 1} ( {H}_{l}^{k + 1} )}^{T} {Q}_{s + 1}^{T}} - \frac{{P}_{s - 1}^{T} {P}_{s - 1} {W}_{s}^{k + 1} {Q}_{s + 1} {H}_{l}^{k + 1} {{D}_{s}^{k + 1} ( {H}_{l}^{k + 1} )}^{T} {Q}_{s + 1}^{T}}{{P}_{s - 1}^{T} {P}_{s - 1} {W}_{s}^{k + 1} {Q}_{s + 1} {{H}_{l}^{k + 1} ( {H}_{l}^{k + 1} )}^{T} {Q}_{s + 1}^{T}} ;$$
letting W₁^{k+1}W₂^{k+1} . . . Wₗ^{k+1} be Gₗ and representing the loss function as follows:
$${F}_{k + 1} \approx {\sum }_{j = 1}^{k} \sqrt{{\sum }_{i = 1}^{m} {( {V}_{k} - {G}_{l} {H}_{l}^{k} )}_{i j}^{2}} + \sqrt{{\sum }_{i = 1}^{m} {( {v}_{k + 1} - {G}_{l} {h}_{l}^{k + 1} )}_{i j}^{2}} ;$$
updating hₗ^{k+1} according to the additive updating rule, expressed as:
$${h}_{l}^{k + 1} = {h}_{l}^{k + 1} - {β}_{l}^{k + 1} \frac{\partial {F}_{k + 1}}{\partial {h}_{l}^{k + 1}} ;$$
wherein a step size for updating hₗ^{k+1} is determined according to the following formula:
$${β}_{l}^{k + 1} = \frac{{h}_{l}^{k + 1}}{{G}_{l}^{T} {G}_{l} {h}_{l}^{k + 1}} ;$$
calculating a partial derivative of Fₖ₊₁ with respect to hₗ^{k+1}, expressed as:
$$\frac{\partial {F}_{k + 1}}{\partial {h}_{l}^{k + 1}} = {G}_{l}^{T} {G}_{l} {h}_{l}^{k + 1} {d}_{l}^{k + 1} - {G}_{l}^{T} {v}_{k + 1} {d}_{l}^{k + 1} ;$$
updating hₗ^{k+1} according to the following formula:
$${h}_{l}^{k + 1} = {h}_{l}^{k + 1} \cdot \frac{{G}_{l}^{T} {G}_{l} {h}_{l}^{k + 1} + {G}_{l}^{T} {v}_{k + 1} {d}_{l}^{k + 1} - {G}_{l}^{T} {G}_{l} {h}_{l}^{k + 1} {d}_{l}^{k + 1}}{{G}_{l}^{T} {G}_{l} {h}_{l}^{k + 1}} ;$$
wherein hₛ^{k+1} is obtained by multiplying hₛ₊₁^{k+1} by Wₛ₊₁^{k+1} expressed as;
$${h}_{s}^{k + 1} = {W}_{s + 1}^{k + 1} {h}_{s + 1}^{k + 1} ;$$
wherein s is smaller than l; and
an updating rule of the hₛ^{k+1} is represented by:
$${h}_{s}^{k + 1} = \{ \begin{matrix}{W}_{s + 1}^{k + 1} {h}_{s + 1}^{k + 1} , s \neq l \\ {h}_{s}^{k + 1} \cdot \frac{{G}_{l}^{T} {G}_{l} {h}_{l}^{k + 1} + {G}_{l}^{T} {v}_{k + 1} {d}_{l}^{k + 1} - {G}_{l}^{T} {G}_{l} {h}_{l}^{k + 1} {d}_{l}^{k + 1}}{{G}_{l}^{T} {G}_{l} {h}_{l}^{k + 1}} , s = l\end{matrix} ;$$
and
(S4) after updating of the basis matrix W is completed, projecting the image samples of the training set and samples to be recognized into a feature space W through steps of:
re-projecting the image samples of the training set to train a support vector machine (SVM) classifier, represented by:
$${H}_{train} = {( {G}_{l}^{T} {G}_{l} )}^{- 1} {G}_{l}^{T} {V}_{train} ;$$
wherein Hₜᵣₐᵢₙ represents a projection of a data matrix of the training set in the feature space, and Hₜᵣₐᵢₙ∈R^{r×n}, Vₜᵣₐᵢₙ, represents a current data matrix of the training set, and Vₜᵣₐᵢₙ∈R^{m×n};
projecting the samples to be recognized as follows:
$${h}_{t e s t} = {( {G}_{l}^{T} {G}_{l} )}^{- 1} {G}_{l}^{T} {v}_{test} ;$$
wherein the samples to be recognized are image samples in the test set; hₜₑₛₜ represents a projection of a sample recognition vector in the feature space, and hₜₑₛₜ∈R^{r×q}, vₜₑₛₜ represents the sample recognition vector, and vₜₑₛₜ∈R^{p×q}; and
classifying feature representations hₜₑₛₜ of the test set by a trained SVM classifier to obtain a predicted label, and comparing the predicted label with an actual label of the test set to calculate recognition accuracy.

2. The RNMF method of claim 1, wherein in step (S3), every time the updating of the training set is completed, a current iteration result of each layer and a historical information are saved for next update; wherein the current iteration result comprises hₛ^{k+1}, dₛ^{k+1} and Wₛ^{k+1}, and the historical information comprises vₖ₊₁, Aₛ and Bₛ, and Aₛ and Bₛ are respectively expressed by:
$$k = \{ \begin{matrix}[ {W}_{s}^{k} {{H}_{s}^{k} ( {H}_{s}^{k} )}^{T} + {V}^{k} {{D}_{s}^{k} ( {H}_{s}^{k} )}^{T} - {W}_{s}^{k} {H}_{s}^{k} {{D}_{s}^{k} ( {H}_{s}^{k} )}^{T} ] + [ {W}_{s}^{k + 1} {{h}_{s}^{k + 1} ( {h}_{s}^{k + 1} )}^{T} + {v}_{k + 1} {{d}_{s}^{k + 1} ( {h}_{s}^{k + 1} )}^{T} - {W}_{s}^{k + 1} {h}_{s}^{k + 1} {{d}_{s}^{k + 1} ( {h}_{s}^{k + 1} )}^{T} ] , & if s = 1 \\ [ {W}_{s}^{k} {{H}_{s}^{k} ( {H}_{s}^{k} )}^{T} + {H}_{s - 1}^{k} {{D}_{s}^{k} ( {H}_{s}^{k} )}^{T} - {W}_{s}^{k} {H}_{s}^{k} {{D}_{s}^{k} ( {H}_{s}^{k} )}^{T} ] + [ {W}_{s}^{k + 1} {{h}_{s}^{k + 1} ( {h}_{s}^{k + 1} )}^{T} + {h}_{s - 1}^{k + 1} {{d}_{s}^{k + 1} ( {h}_{s}^{k + 1} )}^{T} - {W}_{s}^{k + 1} {h}_{s}^{k + 1} {{d}_{s}^{k + 1} ( {h}_{s}^{k + 1} )}^{T} ] , & otherwise\end{matrix}$$
$${B}_{s} = {{H}_{s}^{k} ( {H}_{s}^{k} )}^{T} + {{h}_{s}^{k + 1} ( {h}_{s}^{k + 1} )}^{T} ;$$
wherein s=1, 2, . . . , l.
